(19) United States
(12) Patent Application Publication
(10) Pub. No.: US 2002/0159588 A1
(43) Pub. Date: Oct. 31, 2002

(54) Cryptography with unconditional security for the internet, commercial intranets, and data storage

(76) Inventors: Jason R. Kauffman, Centerville, OH (US); Robert E. Kauffman, Centerville, OH (US)

Correspondence Address: Killworth, Gottman, Hagan & Schaeff, L.L.P., Suite 500, One Dayton Centre, Dayton, OH, 45402-2023, US

(21) Appl. No.: 10/133,046

(22) Filed: Apr. 26, 2002

Related U.S. Application Data
(60) Provisional application No. 60/287,156, filed on Apr. 27, 2001.

(51) Int. Cl. H04L 9/00

(52) U.S. Cl. 380/28

(57) ABSTRACT

In a pseudorandom coding cipher system and method, a sender generates a pseudorandom shift key using a pseudo-random number generator (PRNG) with seed and/or multiplier numbers from a one-time pad. A plaintext message is converted into a numerical synonym string, wherein the first number of the string is shifted with the shift key. The shift value is then passed through a one-way function to place the shift value in the range of numerical synonyms representative of the plaintext alphabet. This process is repeated until the entire numerical string has been shifted with a respective shift key and passed through the one-way function to produce a cryptogram. To decrypt, the reverse operation is performed to recover the plaintext message. Communications between the sender and a receiver is preferably performed according to a double-key lock box scenario employing double use of the above encryption and decryption methods making one-time pad distribution unnecessary.

### BACKGROUND OF THE INVENTION

This invention relates generally to cryptography, and more particularly to data stream enciphering using a nonlinear shift key generator.

The origins of contemporary stream ciphers stems from the one-time pad cryptosystem or Vernam Cipher, named in honor of G. Vernam who developed the-method in 1917 for purposes of telegraphic communication. The one-time pad cryptosystem is one of the simplest and most secure of private-key cryptosystems.

For computers, a one-time pad operates in the following fashion. F₂ denotes the finite field of two elements 0, 1 call bits, wherein a plaintext message is then represented by a string of bits: m=m₁ m₂ . . . mₛ. Before encoding the message string of bits, a sender and a receiver agree on a random key string of bits: k=k₁ k₂ . . . kₜ, where s≧t, which is selected from the one-time pad. The sender then forms the ciphertext bit string: c=c₁c₂ . . . cₛ, by using XOR, modular or rotational arithmetic to combine the bytes of the message string with the bytes of the key string. The ciphertext bit string c is then transmitted to the receiver who decrypts c by forming cᵢ+kᵢ ε F₂, thereby, obtaining plaintext message m. If the key string is used only once and then destroyed, a perfect, unbreakable cipher results. However, in this scheme since the size of the key string must be at least as large as the data size, the cost of implementation of this method is very high as the resulting ciphertext bit string is at least double the size of the plaintext message.

For that reason, a common method of encrypting a plaintext message to reduce the data size of the resulting cryptogram starts by substituting integers for plaintext characters according to some standard numerical alphabet, such as for example, ITA2, ITA5, ASCII or EBCDIC. These integers are then written in their binary form to create a first string, or sequence, of 0's and 1's. To the first string, a second sequence of 0's and 1's is modulo 2-added to produce still a third sequence of 0's and 1's. If the second sequence, being the key sequence, is truly random, an interceptor-attacker will be unable to reproduce the first sequence. The third sequence of 0's and 1's is then transmitted as the encrypted message. In this ciphering scheme, the object is to make the third string of 0's and 1's appear to be a random sequence of digits in binary form. To decrypt, the intended receiver modulo 2-adds the second sequence to the third to recover the first sequence. Thereafter, the original plaintext message is derived from the standard alphabet that was used, e.g., ITA2, ITA5, ASCII or EBCDIC.

There are, however, a number of problems with the latter scheme: First, random number strings are a relatively scarce commodity. Second, the receiver must have the same random number sequence the sender used or must be able to reproduce it. The first of these alternatives still requires the sharing of an enormous amount of key material, which is impractical. The second alternative is impossible if truly random.

To avoid these two difficulties, a pseudo-random number generator is commonly employed by both sender and receiver. A pseudo-random number generator (“PRNG”) is a deterministic machine which produces a string of digits which appears to be random (by passing various statistical tests) due to their long repeat periods. However, when the sender and the receiver use pseudo-random number generators to produce the key sequence, they start with a common initializing “seed” to synchronize the outputs of their generators. Starting with a common initializing “seed” to synchronize the outputs of their generators allows a known-plaintext attack in which an interceptor-attacker gains access to the plaintext (hence to its binary digit string equivalent in terms of some standard numerical alphabet) and to the corresponding ciphertext. By knowing the digits of the binary plaintext string, the attacker is able to reproduce the corresponding pseudorandom number sequence, allowing the attacker to determine the algorithm, the initializing “seed” to recreate the output sequence of the system's pseudo-random number generator, thus “breaking” the code.

Therefore, what is needed is a method to combine a pseudorandom number generator and a simple encoding algorithm to produce an unbreakable cryptographic scheme for communications and data storage that avoids the problems associated with the common encryption method of adding, modulo 2, a pseudo-random bit string to a digitalized plaintext string.

### SUMMARY OF THE INVENTION

The above-mentioned need is met by the present invention in which a cryptographic scheme supplies a multiplier and a seed number of given lengths selected from a one-time pad to a pseudorandom number generator to generate a shift key. A plaintext message is converted to its numerical synonyms for each alphanumerical character that includes space, punctuation, and any keyboard symbols. The shift key is then used to shift each of the numerical synonyms in the message to a different numerical synonym to produce a shifted numerical synonym. A one-way modular math function is then performed on the shifted numerical synonyms to produce a cryptogram. To decipher, the reverse process is carried out.

The multiplier and the seed number are only used once to prevent a mathematical attack of each message by solving two equations and two unknowns. It is to be appreciated that the shift key length is also variable as it may change with each new message enciphering. Additionally, the combination of the one-way function with the one-time shift key generated by the PRNG has an unlimited number of keys of variable lengths and is unconditionally secure even when the algorithm, the plain text and cipher text are available for cryptanalysis. Furthermore, since the shift key is generated by the PNRG, there is not a sharing of an enormous amount of key material.

Since the one-time shift key is symmetrical (used for encoding/decoding), the distribution of the multiplier and seed number between the sender A and the receiver B preferably is carried out such that interception by C, a known draw back of a one-time pad, is prevented. Such as, for example, matrices provided on disks, and any other conventional means of safely transmitting the one-time pad.

Any good number generator with unlimited seeds can be used with the present invention to produce pseudorandomized numbers. Additionally, if desired, two different generators may be combined in into one number generation. This alternative method is similar to a binary shrinking generator, in which the multiplier of a first PRNG may be changed based on the pseudorandom output of a second PRNG. In this manner, unique rules can be established for the possible outputs of the second generator by which to vary the multiplier of the first generator.

In one embodiment, provided is a cipher system for encrypting a plaintext message of alphanumerical characters, generated by a source and transmitted between a sender and a receiver. The cipher system comprises a set of nonnegative numerical synonyms for the alphanumerical characters; and a sender central processing unit adapted to receive the plaintext message of alphanumerical characters from the source and to convert each alphanumerical character of the plaintext message into a respective numerical synonym of the set of nonnegative numerical synonyms to form a numerical message string. The cipher system includes a pseudorandom number generator adapted to generate pseudorandom numbers, the central processing unit being adapted to use the pseudorandom numbers to generate pseudorandom shift keys; and a one-time pad containing a plurality of multipliers and seed numbers accessible to the pseudorandom number generator to generate the pseudorandom numbers, each multiplier and seed number being accessible only once. The cipher system further includes a shift cipher adapted to add to each of the numerical synonym of the numerical message string a respective one of the pseudorandom shift keys to generate a shifted numerical message string; and a one-way function adapted to perform modular subtraction on each numerical value of the shifted numerical message string to generate a ciphertext string having numerical values in the set of nonnegative numerical synonyms.

In another embodiment provided is a method for using a cipher system to transmit a plaintext message of alphanumerical characters, generated by a source, between a sender and a receiver. The method comprises receiving the plaintext message of alphanumerical characters by a sender central processing unit; converting each character of the plaintext message to a related numerical synonym, and providing a seed and/or multiplier number from a one-time pad. The method further includes generating pseudorandom numbers with a pseudo-random number generator using the seed and/or multiplier number, each of the seed and/or multiplier number being only accessible once from the one-time pad by the pseudo-random number generator; generating a shift key from the pseudorandom numbers; shifting a first numerical synonym of the plaintext message with the shift key to generate a shifted numerical value; and passing the shifted numerical value through a one-way function adapted to perform modular subtraction on the shifted numerical value to generate ciphertext having a numerical value in the set of nonnegative numerical synonyms. The method further includes reseeding the pseudo-random number generator with the pseudorandom numbers to generate new pseudorandom numbers; and repeating until every one of the numerical synonyms of the plaintext message has been shifted and passed through the one-way function to form a cryptogram.

### BRIEF DESCRIPTION OF THE DRAWINGS

The accompanying drawings which are incorporated in and constitute a part of the specification, illustrate preferred embodiments of the invention and together with the general description of the invention given above and the detailed description of the preferred embodiments given below, serve to explain the principles of the invention.

FIG. 1 is a flow chart illustrating the receipt of the first plaintext character to be transmitted using the present invention; and

FIG. 2 is a flow chart illustrating a basic embodiment of the invention associated with the reception and decryption of the encoded message.

### DETAILED DESCRIPTION OF THE PREFERRED EMBODIMENTS

Reference will now be made in detail to the present preferred embodiments of the invention. We now describe the invention and indicate how it avoids the problems associated with the common encryption method of adding, modulo 2, a pseudo-random bit string to a digitalized plaintext string.

First, a definition is provided of specific terms which are incorporated herein:

Digits are the first ten nonnegative integers, 0, 1, . . . , 9. A random (pseudo-random) integer is a finite sequence of randomly (pseudo-randomly) selected digits. All integers are to be regarded as nonnegative unless otherwise indicated.

A plaintext alphabet is a set of linguistic characters sufficient to generate to-be-encrypted messages. It might consist of, say, the English alphabet, common words, digits, digraphs, acronyms and punctuation marks, pixel colors, digitized sound, for example. A plaintext alphabet can be represented by codes suitable for computer use, such as ITA2, ITA5, ASCII, EBCDIC, or any other suitable computer codes.

In the illustrative embodiments to follow, it is to be appreciated that a pseudorandom number generator (“PRNG”) is used to generate random integers to form shift keys of variable length. However, other pseudorandom number generator methods may be used such as, for example, using multiple random number sequences generated from multiple separate input seeds to further provide a randomized shift key of variable length (under control of the central processing unit), wherein searching for the seed is difficult as the core mathematical problem of the algorithm itself. Furthermore, reseeding of the PRNG (i.e. adding more random seed material) is performed at regular intervals (i.e., after each message) to thwart attackers from attacking the PRNG's state, by making the seed a moving target for attackers, reducing the possibility of seed attacks.

A computer may be programmed according to a ciphering method of the present invention to use integer numbers generated by a PRNG to produce a large numbered shift key (i.e., up to 128 number keys). The pseudo-randomized generated shift key, for example, is then used to shift ASC II values of a plaintext message. In using ASC II values, adder/subtracter and one-way modular math functions realign/place the shifted ASC II in the range of values that represent alphanumerical characters in order to account for those ASC II values corresponding to computer functions (i.e. carrier return, shift, etc.), which cannot be used when encoding a plaintext message in ASC II. Accordingly, it is to be appreciated that if another set of numerical synonyms is used which do not include computer functions then the adder/subtracter function as explain hereinafter, would be an unnecessary processing step.

In the foregoing example, a PRNG generates the integers 3, 9, 8, which the processor then uses to form a shift key of 398 (e.g., [3*100]+[9*10]+8). The math to encode “.” with the illustrative PRNG generated shift key of 398 is as follows: the ASC II value of “.”, which is 46, is subtracted by 32 to account for ASC II values 0-31 not being available since designated computer functions. The resulting value of 14 is then added to the shift key to give a shifted value of 412. The shifted value is then passed through a one-way modular math function, which repeatedly subtracts 94 (i.e., 126−32=94, which represents the useable alphanumerical range of ASCII values) from the shifted value until below 95, resulting in a mod value of 36. Finally, to once again account for non-useable ASC II values 0-31, 32 is added to the mod value to produce a ciphertext value of 68, which represents “D.”

It is to be appreciated in the above example, that the shift key to convert “.” to “D” cannot be determined by cryptanalysis since the shift key could be 022, 116, 210, 304 and so on, i.e., one equation two variables. Additionally, the length of the shift key is also unknown, as the key length can be made to vary with each new message. Therefore, combining the one-time use of keys generated by the PRNG, which by the integer method can generate an unlimited number of shift keys of variable lengths, results in an unconditionally secure cipher system even when the plain text and cipher text are available for cryptanalysis.

To decode the above illustrative ciphertext “D”, the ASC II value of the ciphertext, which is 68, is subtracted by 32 to again account for ASC II values 0-31 not being available since designated computer functions, and then subtracted by the shift key to produce a negatively shifted value. The negatively shifted value is then repeatedly added by 94 (which again represents the useable alphanumerical range of ASCII values) from the negatively shifted value until above −1, resulting in a mod value of 14. Finally, to once again account for non-useable ASC II values 0-31, 32 is added to the mod value to produce a plaintext value of 46, which represents “.”. A systems implementation of the above-described ciphering method of the present invention now follows.

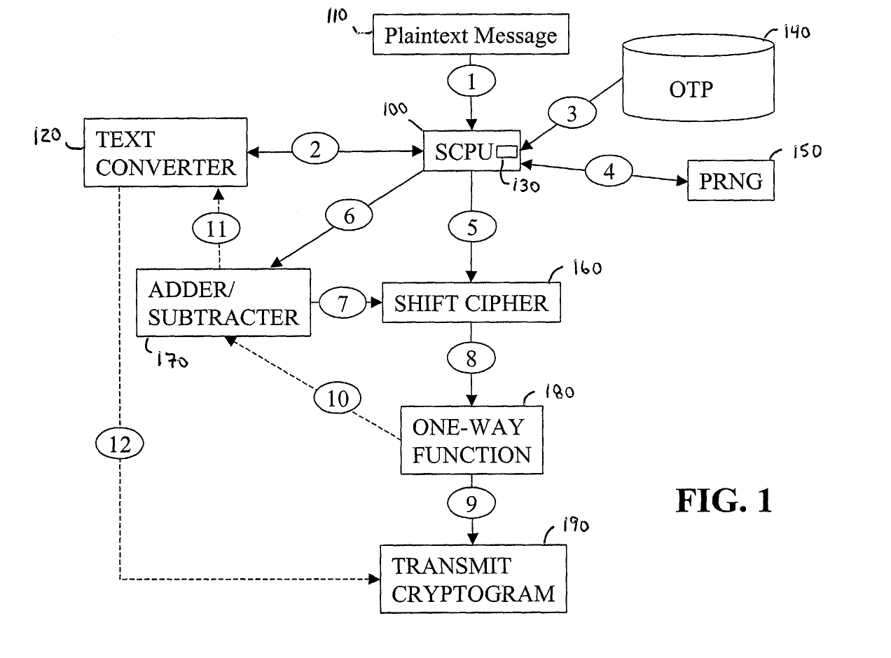

FIG. 1 is a flow chart illustrating a cipher system of the present invention for encrypting a plaintext message of alphanumerical characters, generated by a source, and transmitted between a sender and a receiver. In the illustrative embodiment, the plaintext message to be encrypted is received by a sender central processing unit (“SCPU”) 100, via link 1 from a source 110. Once received, the SCPU 100 converts each alphanumerical character of the plaintext message into a respective numerical synonym read from a set of nonnegative numerical synonyms 120, via link 2, to form a numerical message string, wherein the SCPU includes memory 130 to store the numerical message string.

In addition, the SCPU 100 retrieves a multiplier and seed number from a computer readable medium 140 (i.e., RAM, ROM, a hard disk, floppy, flash card, etc.) via link 3 and activates a pseudorandom number generator 150 (“PRNG”) with the multiplier and seed number, via link 4. The PRNG 150 generates random nonnegative integers, which the SCPU 100 uses as part of any suitable mathematical operation (add, subtract, multiple, divide, group, etc.) to form into a shift key. The SCPU 100 then sends the shift key, via link 5, to a shift cipher 160.

Before sending the numerical message string to the shift cipher 160, the SCPU may be instructed to realign/place each numerical value of the numerical message string in a useable range of numerical synonyms, such as was necessary in the above illustrative example which used ASC II code. If so programmed, the SCPU will then send, via link 6, the numerical message string to an adder/subtracter 170 to subtract from each numerical synonym in the numerical message string a value to bind the numerical message in the useable numerical range.

Next, the shift cipher 160 adds the random shift key to each numerical synonym of the numerical message string, received via either link 5 or 7, depending on the set of numerical synonyms used, to form a shifted numerical message string. The shifted numerical message string is then sent via the link 8 to a one-way function 180 adapted to perform modular subtraction on each numerical value of the shift numerical message string to generate a ciphertext string having numerical values in the set of nonnegative numerical synonyms. The resulting ciphertext string or cryptogram is sent to a transmitting module 190, via link 9, in order for the cryptogram to be sent to an intended recipient.

Optionally, the output of the one-way function 180 may be sent via link 10 to the adder/subtracter 170 to add the subtracted value previously used if conversion of the numerical cryptotext string to alphanumerical characters is desired. In this alternative embodiment, the output of the adder/subtracter 170 is then sent to the text converter 120 via link 11. The cryptogram is then sent for transmission, after conversion by text converter 120 to its alphanumerical characters, via a link 12. It is to be appreciated that sending and/or receiving a cryptogram produced by the present invention increases e-mail speeds because there is only the need to transmit the encoded message without the keying material embedded therein, and/or having to provide a cryptogram twice as long as the original message.

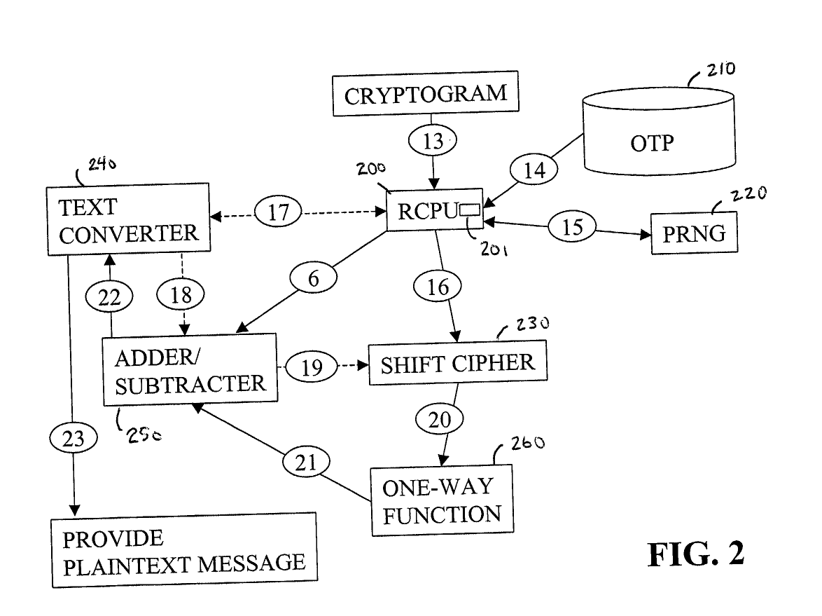

FIG. 2 is a flow chart illustrating a basic embodiment of the invention associated with the reception and decryption of a cryptogram. Upon receipt of the cryptogram from the receiver (e-mail, radio receiver, etc.) via a link 13, a receiver computer processing unit (“RCPU”) 200, also having memory 201, performs a reverse operation on the cryptogram. The RCPU accesses a multiplier and/or seed number from the receiver's one-time pad 210, via link 14, so that the receiver's PRNG 220 will generate and return a shift key via link 15. In one embodiment, the sender's one-time pads 150 and the receiver's one-time pad 210 are synchronized by other secret means conventionally known in the art, such that the outputs of the sender's PRNG 150 and receiver's PRNG 220 will enable the SCPU 100 and RCPU 200 to generate the same shift key. The same shift key used to encrypt the cryptogram and generated by the RCPU 200 is then sent to the receiver's shift cipher 230, via link 16.

If the cryptogram received is presented in alphabetic characters, then the RCPU 200 converts the cryptogram to its numerical synonym values using the receiver's text converter 240 via link 17, and then to the receiver's adder/subtracter 250 via link 18. The resulting numerical values of the cipher string would then be sent to the shift cipher 230 via link 19 for performing the reversing operation. Otherwise, if the received cryptogram received is in numerical format, -then the RCPU 200 sends the numerical string directly to the shift cipher 230. In either case, the output of the shift cipher 230 is then sent to the receiver's one-way function 260, via link 20. The output of the one-way function 260 is then sent to the adder/subtracter 250 via link 21 to place the numerical output of the one-way function 260 in the numerical synonym range. The numerical synonym output of the adder/subtracter 250 is then sent to the text converter 240 to convert the numerical output to its corresponding alphabetical characters via link 22. The output of the text converter 240, being the deciphered plaintext message, is then provided as readable output, e.g., display screen, printer, via link 23.

Preferably, with the above encryption and decryption method disclosed by FIGS. 1 and 2, respectively, communications between the sender and receiver in another embodiment is carried out according to a double-key lock box method. The main advantage of the double-key lock box method of the present invention is that it allows encryption and decryption without the need for exchanging seeds/multipliers of the one-time pads 140 and 210. Furthermore, the sender's and receiver's one-time pads do not have to be synchronized or be the same. With the double-key lock box method, no key material is exchanged, as the seeds/key lengths are known only to the user encrypting. Also, the double-key lock box method allows for sender/receiver verification through an encrypted password or at least by having possession of their own onetime pad.

In performing the double-key lock box without sender/receiver verification, the sender encrypts a plaintext message and transmits a cryptogram by the above disclosed encryption method of FIG. 1. Upon receiving the cryptogram, the receiver also uses the above encryption method of FIG. 1 to encrypt the received cryptogram and to transmit the now double encrypted cryptogram back to the sender. The sender decrypts the double encrypted cryptogram according to the decryption method disclosed by FIG. 2, but then retransmits the now receiver encrypted cryptogram to the receiver. Upon receiving the cryptogram, the receiver then uses the decryption method disclosed by FIG. 2 to recover the plaintext message.

To provide for sender/receiver verification in the double-key lock box method, the receiver first uses the encryption method disclosed by FIG. 1 to encrypt and transmit an encrypted password. Upon receipt of the encrypted password, the sender uses the encryption method disclosed by FIG. 1 to encrypt/transmit a plaintext message and the now double encrypted password. Upon receiving the cryptogram, the receiver uses the encryption method disclosed by FIG. 1 to encrypt and transmit a double encrypted cryptogram and uses the decryption method disclosed by FIG. 2 to decrypt and transmit the sender encrypted password. The sender uses the decryption method disclosed by FIG. 2 to decrypt the double encrypted cryptogram and the sender encrypted password to verify the receiver. The sender now transmits the receiver encrypted cryptogram, wherein the receiver uses the decryption method disclosed by FIG. 2 to recover the plaintext message.

It is to be appreciated that additional passwords could be added to verify the sender and/or that a password keeper authority may be used to provide the same password to sender and receiver, which are then added to the message for each others verification. Since in the above double-key lock box method passwords are kept secret, sender and receiver could communicate endlessly with one password since keys are not exchanged. Furthermore, since no exchange of keys or PRNG synchronization is necessary, the sender or receiver may have access to the same or a different one-time pad. Again, the only constraint is the one time use of the seed and multipliers numbers by either sender or receiver.

In the operation of the above described ciphering and decipher routine of the present invention, it is to be appreciated that each numerical synonym of the plaintext message is shifted by it own pseudo-randomly produced shift key. Preferably, the output of the PRNG is used to reseed its input, such that a series of pseudo-randomized shift keys is generated and used by the CPU's 100 and 200.

Further, it is to be appreciated that in addition to letters, symbols, punctuation marks, and the likes from a keyboard, the present invention can also be used with pictures and sound. In each case, each pixel color or digitized note in a message and/or picture is converted into a number by a suitable configured converter 120, wherein the remainder of cryptological method is performed as described, with possibly the modification of performing nested loops instead of a single loop to read the message/picture as known in the art.

In the foregoing specification, the invention has been described with reference to specific embodiments. However, one of ordinary skill in the art appreciates that various modifications and changes can be made without departing from the skill of the present invention as set forth in the claims below. Accordingly, the specification and figures are to be regarded in an illustrative rather than a restrictive sense, and all such modifications are intended to be included within the scope of the present invention.

What is claimed is:

1. A cipher system for encrypting a plaintext message of alphanumerical characters, generated by a source and transmitted between a sender and a receiver, comprising:
a set of nonnegative numerical synonyms for the alphanumerical characters;
a sender processing unit adapted to receive the plaintext message of alphanumerical characters from the source and to convert each alphanumerical character of the plaintext message into a respective numerical synonym of said set of nonnegative numerical synonyms to form a numerical message string;
a pseudorandom number generator adapted to generate pseudorandom numbers, said processing unit being adapted to use said pseudorandom numbers to generate pseudorandom shift keys;
a one-time pad containing a plurality of multipliers and seed numbers accessible to said pseudorandom number generator to generate said pseudorandom numbers, each multiplier and seed number being accessible only once;
a shift cipher adapted to add to each said numerical synonym of said numerical message string a respective one of said pseudorandom shift keys to generate a shifted numerical message string; and
a one-way function adapted to perform modular subtraction on each numerical value of said shifted numerical message string to generate a ciphertext string having numerical values in said set of nonnegative numerical synonyms.

2. The cipher system of claim 1, further comprising:
a receiver processing unit to receive said ciphertext string, to decode said ciphertext by subtracting from each said numerical value of said ciphertext string said respective one of said pseudorandom shift keys and performing modular addition to recover said numerical message string, and to convert said numerical message string to the plaintext message of alphanumerical characters; and
a transmitting module to transmit said cryptotext string to said receiver processing unit.

3. The cipher system as claimed in claim 1, wherein said set of nonnegative numerical synonyms is one selected from the group consisting of ITA2, ITA5, ASCII, EBCDIC, and any other suitable computer codes.

4. The cipher system as claimed in claim 1, wherein each said shift key has a variable length under the control of the processing unit.

5. The cipher system as claimed in claim 4, wherein said shift key has a length up to 128 numbers.

6. The cipher system as claimed in claim 1, wherein said one-time pad is provided on a computer readable medium selected from the group consisting of RAM, ROM, a hard disk, floppy, flash card, and combinations thereof.

7. The cipher system as claimed in claim 1, wherein said pseudorandom numbers are nonnegative integers.

8. A method for using a cipher system to transmit a plaintext message of alphanumerical characters, generated by a source, between a sender and a receiver, comprising:
receiving the plaintext message of alphanumerical characters by a sender processing unit;
converting each character of the plaintext message to a related numerical synonym;
providing a seed and/or multiplier number from a one-time pad;
generating pseudorandom numbers with a pseudo-random number generator using said seed and/or multiplier number, each said seed and/or multiplier number being only accessible once from said one-time pad by said pseudo-random number generator;
generating a shift key from said pseudorandom numbers;
shifting a first numerical synonym of said plaintext message with said shift key to generate a shifted numerical value;
passing said shift numerical value through a one-way function adapted to perform modular subtraction on said shifted numerical value to generate ciphertext having a numerical values in said set of nonnegative numerical synonyms;
reseeding said pseudo-random number generator with said pseudorandom numbers to generate new pseudorandom numbers; and
repeating until every said numerical synonym of said plaintext message has been shifted, passed through said one-way function to form a cryptogram.

9. A method of claim 8 further including providing a receiver processing unit to receive said cryptogram and to decode each character of said cryptogram by performing a reverse operation, and transmitting said cryptogram to said receiver processing unit.

10. The method of claim 9 wherein said reverse operation comprises subtracting from each numerical value of said cryptogram a respective one of said shift key and performing modular addition to recover said related numerical synonym numerical of the plaintext message, and converting each said numerical synonym to a related alphanumerical characters to reproduce the plaintext message.

11. The method of claim 8 wherein said related numerical synonym is one selected from the group consisting of ITA2, ITA5, ASCII, EBCDIC, and any other suitable computer codes.

12. The method of claim 8 wherein each said shift key has a variable length under the control of the processing unit.

13. The method of claim 12 wherein said shift key has a length up to 128 numbers and said pseudorandom numbers are nonnegative integers.

14. The method of claim 8 wherein said one-time pad is provided on a computer readable medium selected from the group consisting of RAM, ROM, a hard disk, floppy, flash card, and combinations thereof.

15. The method of claim 8 further comprising providing a receiver processing unit to receive said cryptogram, transmitting said cryptogram to said receiver processing unit, wherein said receiver processing unit re-encrypting said cryptogram according to claim 8 and transmits a now double encrypted cryptogram to said sender processing unit.

16. The method of claim 15 further comprising said sender processing unit receiving said double encrypted cryptogram and decrypting said double encrypted cryptogram by performing a reverse operation and transmitting a now receiver encrypted cryptogram to said receiver processing unit.

17. The method of claim 16 further comprising said receiver processing unit receiving said receiver encrypted cryptogram and performing a reverse operation on said receiver encrypted cryptogram to recover the plaintext message.

18. The method of 15 wherein before said sender processing unit encrypts said plaintext message, said receiver processing unit encrypts according to the method of claim 8 and transmits an encrypted password to said sender processing unit, which upon receipt of said encrypted password encrypts said plaintext message and transmits to said receiver processing unit said cryptogram and a now double encrypted password.

19. The method of claim 18 further comprising said receiver processing unit encrypting said cryptogram according to the method of claim 8 upon receipt from said sender processing unit, decrypting said double encrypted password by performing a reverse operation, and transmitting a now double encrypted cryptogram and a now sender encrypted password.

20. The method of claim 19 further comprising said sender processing unit decrypting said double encrypted cryptogram and said sender encrypted password to verify the receiver by performing a reverse operation, and transmitting to said receiver processing unit a now receiver encrypted cryptogram, wherein said receiver processing unit decrypts said receiver encrypted cryptogram by a reverse operation to recover said plaintext message.
